(19) United States
(12) Patent Application Publication
(10) Pub. No.: US 2026/0203620 A1
(43) Pub. Date: Jul. 16, 2026

(54) SYSTEMS AND METHODS OF DETECTING NECESSITATED INTERVENTION

(71) Applicant: University of Georgia Research Foundation, Inc., Athens, GA (US)

(72) Inventor: Jill K. JINKS, Atlanta, GA (US)

(21) Appl. No.: 19/133,865

(22) PCT Filed: Nov. 30, 2023
(86) PCT No.: PCT/US2023/081713

§ 371 Date: May 29, 2025

Related U.S. Application Data
(60) Provisional application No. 63/430,688, filed on Dec. 7, 2022.
(60) Provisional application No. 63/448,432, filed on Feb. 27, 2023.

(51) Int. Cl. G06N 5/048; A63F 13/58; G09B 7/00

(52) U.S. Cl. CPC G06N 5/048; A63F 13/58; G09B 7/00

(57) ABSTRACT

Disclosed are various embodiments for detecting necessitated intervention. Some embodiments can receive a plurality of instances of data, each instance of data corresponding to an action being performed over a period of time. At least some embodiments can calculate a performance score for each instance of data and then generate a time series plot based on the performance score for two or more instances of data and based on the corresponding period of time for the two or more instances of data. At least some embodiments can measure the time series plot to generate a fractal dimension for the time series plot. At least some embodiments can rescale the fractal dimension to generate a rescaled fractal dimension. At least some embodiments can provide an intervention in response to determining that the rescaled fractal dimension is within a specified range.

### CROSS REFERENCE TO RELATED APPLICATIONS

This application claims priority to, and the benefit of, co-pending U.S. provisional application entitled “SYSTEMS AND METHODS OF DETECTING NECESSITATED INTERVENTION” having Ser. No. 63/448,432, filed Feb. 27, 2023, which is hereby incorporated by reference in its entirety.

This application also claims priority to, and the benefit of, co-pending U.S. provisional application entitled “INCIDENTAL LEARNING IN COMPLEXITY: MEASURING THE ROUGHNESS OF LEARNING” having Ser. No. 63/430,688, filed Dec. 7, 2022, which is also hereby incorporated by reference in its entirety.

### BACKGROUND

A learning curve is typically a measure used to describe the time and effort humans assert to gain knowledge. The learning curve presumes that learning is linear or quasi-linear with an upward trend. Relying on that system yields a theory that once humans obtain knowledge, the knowledge remains with that person indefinitely.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in a computing environment in the network environment of FIG. 1 according to various embodiments of the present disclosure.

### DETAILED DESCRIPTION

Disclosed are various approaches for detecting necessitated intervention. Learning can be thought of as a process to gain knowledge. Learning occurs throughout the lifetime of an intelligent entity, like learning to speak or walk, learning to read and write, learning how to perform various activities for work or pleasure, and learning how to improve oneself. The “learning curve” is typically the measure used to describe the time and effort that entities assert to gain knowledge. The learning curve theory suggests a way to understand the improved performance of an entity or investment over time. The idea is that the more an entity does something, the better they will get at it, which translates to lower cost and higher output in the long term. Learning curve theory acknowledges that the learning progress is influenced by a number of variables, including time, previous experience, quality of training and so on. As a result, tracking only one of these variables might give misleading data. However, some performance progress is difficult to quantify and measure. If there is no specific deliverable, such as a product or a sale, it can be hard to define a single unit of output for the purpose of measuring progress. Because there are so many variables that can impact performance, it is important that the learning curve model is used in combination with other methods of tracking performance for a more complete picture.

Additionally, the learning curve does not represent the retention of the learning experience by the learner as useful knowledge to be applied in different and future contexts. Thus, the wholeness of the experience is not considered learning in learning curve theory. The only learning ‘valued’ is learning that reduces the time needed to complete a given task. The omission of the unvalued learning endorses a notion of learning and knowledge acquisition that is task and skill focused. Accordingly, the learning curve is incomplete on its own.

Instead of viewing learning as an upward curve, it can be more practical to imagine learning as more turbulent and learning can more realistically be measured as a roughness of learning. As conceptualized, the roughness of learning variable is multidimensional and assumes that all prior learning and knowledge acquisition is relevant in any given context. Complexity science offers a platform for estimating the roughness of learning to allow the inclusion of this dimension of human learning to be measured and included in the study of human learning and human adaptive practices. Greater insight into the dimensionality of human learning as described by the roughness of learning will allow researchers to examine broader sets of inputs in understanding both the learning process and the knowledge acquired, which may be much larger than previously acknowledged and valued.

The roughness of learning variable attempts to measure that irregularity and ambiguity, and provide a proxy measure to estimate the energy, entropy and time associated with a learning effort. As conceptualized, the roughness of learning, by definition, includes prior learning and experience in terms of its inputs. Depending on the prior learning experience, the input variables associated with prior learning, in the form of experience and time vary from learner to learner. Similarly, the ability to aggregate prior learning and experience at a community or organizational level is reflected in the collective roughness of learning associated with a given state.

The roughness of learning is distinguished from comparisons to the learning curve as the roughness of learning includes complexity science-based concepts of entropy, energy, time, and nonlinear interactions within the learning process. Learning can be jagged, irregular, and rough, yet at a given scale, we can identify a pattern. To the extent learning behavior can be observed and mapped, such as a series of stock market trades over time in a given environment, an estimate of the roughness of learning can be used in a model of adaptive capacity by calculating the fractal dimension of the learning-map we create, much like an EKG maps heartbeats and pressure. The social sciences use fractals to measure irregularity to provide a quantitative measure of observed and latent behavior over a defined time period. Accordingly, various techniques can estimate individual and social learning in a dynamical situation using complexity theory and fractals.

Utilizing these techniques, a system can be utilized to determine the level in which an entity is learning. In at least some situations, an entity can be successful with learning on their own without any outside intervention. Instead, providing intervention in a situation where the entity is successful with learning may ultimately harm the entity's ability to learn. In some situations, an entity can be stuck in the learning process. In such a situation, intervention by an administrator is required to overcome such an obstacle. However, determining when to provide an intervention can be difficult to determine. What may look like an entity struggling with the material could be easily misinterpreted as successful trial and error of learning. Accordingly, a need exists to objectively identify the performance of an entity to determine whether the entity is successfully learning, or whether the entity needs intervention to overcome their struggles (a “necessitated intervention”).

Various embodiments of this disclosure are directed to detecting necessitated intervention. Because learning occurs throughout various contexts, embodiments of this disclosure can also be directed to detecting a necessitated intervention in various contexts. This disclosure describes the underlying systems and methods for detecting necessitated intervention, as well as various embodiments in various contexts. For instance, this disclosure also describes systems and methods for detecting that a player requires intervention in a video game, systems and methods for detecting that a flight plan for a plane within an airline requires intervention, systems and methods for detecting that a person requires intervention to lose weight, and systems and methods for detecting that a person requires intervention to obtain education objectives. Each of these embodiments will be further described throughout the disclosure.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

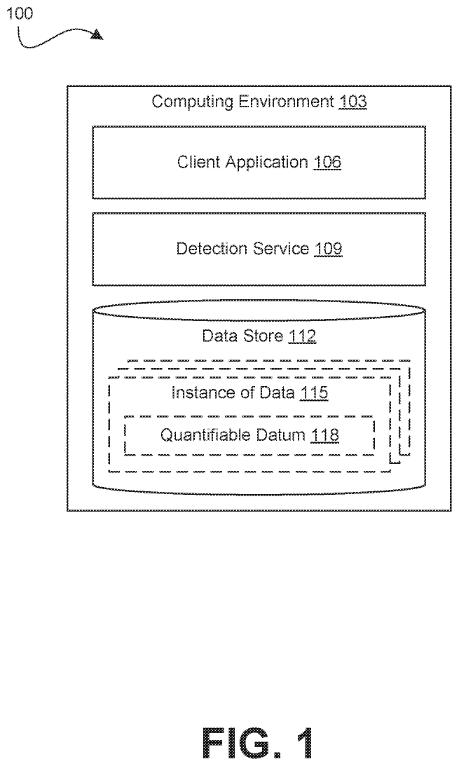

With reference to FIG. 1, shown is a network environment 100 according to various embodiments. The network environment 100 can include a computing environment 103, which can be in data communication with various other computing devices via a network. The network can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network can also include a combination of two or more networks. Examples of networks can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

Alternatively, the computing environment 103 can be representative of a plurality of client devices that can be coupled to the network. The computing environment 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The computing environment 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the computing environment 103 or can be connected to the computing environment 103 through a wired or wireless connection.

The computing environment 103 can be configured to execute various applications such as a client application 106. The client application 106 can be executed in a computing environment 103 to access network content served up by other servers, thereby rendering a user interface on the display. To this end, the client application 106 can include a browser, a dedicated application, or other executable, and the user interface can include a network page, an application screen, or other user mechanism for obtaining user input. The computing environment 103 can be configured to execute the client application 106, such as email applications, social networking applications, word processors, spreadsheets, or other applications.

Various applications or other functionality can be executed in the computing environment 103. The components executed on the computing environment 103 include a detection service 109, and other applications, services, processes, systems, engines, or functionality not discussed in detail herein.

The detection service 109 can be executed to detect a necessitated intervention. The detection service 109 can receive a plurality of instances of data 115, each instance of data 115 corresponding to an action being performed over a period of time. The detection service 109 can then calculate a performance score for each instance of data 115 and then generate a time series plot based on the performance score for two or more instances of data 115 and based on the corresponding period of time for the two or more instances of data 115. The detection service 109 can then measure the time series plot to generate a fractal dimension for the time series plot. The detection service 109 can then rescale the fractal dimension to generate a rescaled fractal dimension. The detection service 109 can then provide an intervention in response to determining that the rescaled fractal dimension is within a specified range.

Also, various data is stored in a data store 112 that is accessible to the computing environment 103. The data store 112 can be representative of a plurality of data stores 112 which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store 112. The data stored in the data store 112 is associated with the operation of the various applications or functional entities described below. This data can include instances of data 115, and potentially other data.

The instances of data 115 can represent a plurality of datum (such as quantifiable datum 118) that corresponds to an event, a period of time, an action, and/or some discrete element or entity. In at least one embodiment, each instance of data 115 can represent a fixed period of time. Examples of a fixed period of time can include one or more minutes, one or more hours, one or more days, one or more months, one or more years, etc. In at least one embodiment, each instance of data 115 can represent a variable period of time. In at least some embodiments, a variable period of time can be represented by a starting event and an ending event. However, in some embodiments, the variable period of time can be the amount of time it takes to complete a specified event or action. Examples of variable periods of time include a time that a person is playing a video game (or the time to play a round of a video game); a time between pre-boarding a plane, boarding the plane, taxing the plane, flying the plane, landing the plane, and/or debarking from the plane; and/or a time to take an assessment. To further detail some of the examples, a round of a video game can be represented by some starting time, like when a player spawns or respawns; some time when a player has a loss in value, like losing points, in-game currency, or losing an in-game life; and/or some ending time, like when a round has completed or when an in-game player dies.

The instances of data 115 can also include categorization information about the entity or person that is generating the instance of data 115. For example, an instance of data 115 can be generated by an entity having lower skill in the action, average skill in the action, or high skill in the action. Being able to categorize the instances of data 115 based on the entity or person can allow the system to more finely tune expected results for the instances of data 115.

The instances of data 115 can include quantifiable datum 118. The quantifiable datum 118 can be representative of a piece of datum that, when combined with other datum and/or weights, can be used to calculate a score for the instance of data 115 for which the quantifiable datum 118 is related. In many embodiments, the quantifiable datum 118 can be represented as one or more numbers (e.g., integers, percentages, decimals, floats, longs, etc.). In some embodiments, the quantifiable datum 118 can be represented as a string value, which may correspond to values that can be mapped to a numerical value. For example, quantifiable datum 118 could store a string value such as a color; such a string value may be mapped to provide a numerical value that corresponds to that string.

There are various examples of quantifiable datum 118. In examples of instances of data 115 for a video game, quantifiable datum 118 can include position data of an in-game character (e.g., directional positions, position in a story, position as it relates to a goal, etc.), one or more statuses of the in-game character (e.g., health, lives, hunger, ammo, etc.), and/or environment information for the game (e.g., the environment around the in-game player, the level which is being played, organization of elements within the game, etc.).

In examples of instances of data 115 for a travel company (such as flight data), quantifiable datum 118 can include pre-boarding data (e.g., time to clean the plane, time to load the luggage, time to prepare flight crew, refueling times, delays due to the airport, etc.), boarding data (e.g., time to load passengers onto a plane, delays due to the airport, etc.), taxiing data (e.g., time from departure to take-off, delays due to weather, delays due to air traffic control, delays due to the airport, whether the passengers were required to deplane, etc.), flight data (e.g., take-off time, landing time, time in the air, average speed, speed at each moment, altitude, fuel utilized, balance of the plane, the flight path, distance traveled, etc.), landing data (e.g., landing time, delays waiting for runway, etc.), and/or post-landing data (e.g., distance of runway to gate, time to taxi from runway to gate, unloading/debarking passengers time, unloading baggage time, cleaning time, time to change flight crew, time to refuel the plane, etc.). Various other quantifiable datum 118 can also be included and other information can be included for a flight or an airport.

In examples of instances of data 115 for health data, quantifiable datum 118 can include a person's data (e.g., weight, height, dimensions/measurements, percentage fat, percentage water, muscle mass, blood pressure, etc.), prescription information (e.g., quantity and dosage of medicines, etc.), medical records (e.g., doctor's records, dental records, etc.), food information (e.g., food intake diary, caloric intake, water intake, etc.), fitness information (e.g., workouts, quantities of actions performed, time performing workout, etc.), and various other information.

In examples of instances of data 115 for educational data, quantifiable datum 118 can include assessment data (e.g., test scores, question responses, time to answer a question, time to complete the test, etc.), studying data (e.g., time spent reading, time spent studying, etc.), and various other information.

Next, a general description of the operation of the various components of the network environment 100 is provided. To begin, the detection service 109 can receive a plurality of instances of data 115, each instance of data 115 corresponding to an action being performed over a period of time. The detection service 109 can then calculate a performance score for each instance of data 115 and then generate a time series plot based on the performance score for two or more instances of data 115 and based on the corresponding period of time for the two or more instances of data 115. The detection service 109 can then measure the time series plot to generate a fractal dimension for the time series plot. The detection service 109 can then rescale the fractal dimension to generate a rescaled fractal dimension. The detection service 109 can then provide an intervention in response to determining that the rescaled fractal dimension is within a specified range.

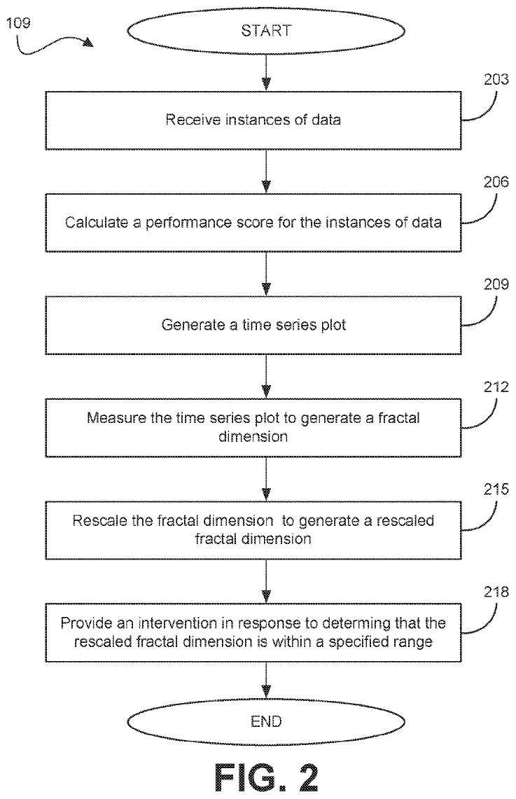

Referring next to FIG. 2, shown is a flowchart that provides one example of the operation of a portion of the detection service 109. The flowchart of FIG. 2 provides merely an example of the many different types of functional arrangements that can be employed to implement the operation of the depicted portion of the detection service 109. As an alternative, the flowchart of FIG. 2 can be viewed as depicting an example of elements of a method implemented within the network environment 100.

Beginning with block 203, the detection service 109 can receive a plurality of instances of data 115. In at least some embodiments, each instance of data 115 can correspond to an action being performed over a period of time. In at least one embodiment, each instance of data 115 can represent a fixed period of time. Examples of a fixed period of time can include one or more minutes, one or more hours, one or more days, one or more months, one or more years, etc. In at least one embodiment, each instance of data 115 can represent a variable period of time. In at least some embodiments, a variable period of time can be represented by a starting event and an ending event. However, in some embodiments, the variable period of time can be the amount of time it takes to complete a specified event or action. Examples of variable periods of time include a time that a person is playing a video game (or the time to play a round of a video game); a time between pre-boarding a plane, boarding the plane, taxing the plane, flying the plane, landing the plane, and/or debarking the plane; and/or a time to take an assessment. To further detail some of the examples, a round of a video game can be represented by some starting time, like when a player spawns or respawns; some time when a player has a loss in value, like losing points, in-game currency, or losing a life; and/or some ending time, like when a round has completed or when an in-game player dies.

The instances of data 115 can also include categorization information about the entity or person that is generating the instance of data 115. For example, an instance of data 115 can be generated by an entity having lower skill in the action, average skill in the action, or high skill in the action. Being able to categorize the instances of data 115 based on the entity or person can allow the system to more finely tune expected results for the instances of data 115.

In at least one embodiment, the detection service 109 can receive a plurality of instances of video game data (i.e., instances of data 115). In at least some embodiments, each instance of video game data can be corresponding to a period of time which the player is playing the video game. In at least one embodiment, the period of time is indicative of a period of play time between starting the game and a player failure. In such an embodiment, the player failure can be at least one of an in-game death, an end of round of game play, or a loss of an in-game value, or other various points in time to identify a start and end of a portion of game time. In some embodiments, each instance of video game data can comprise position data of an in-game character (e.g., directional positions, position in a story, position as it relates to a goal, etc.), one or more statuses of the in-game character (e.g., health, lives, hunger, ammo, etc.), and/or environment information for the game (e.g., the environment around the in-game player, the level which is being played, organization of elements within the game, etc.).

In at least another embodiment, the detection service 109 can receive a plurality of instances of flight data (i.e., instances of data 115). In at least some embodiments, each instance of flight data can correspond to a flight within a flight plan. In at least some embodiments, the flight data can include pre-boarding data (e.g., time to clean the plane, time to load the luggage, time to prepare flight crew, refueling times, delays due to the airport, etc.), boarding data (e.g., time to load passengers onto a plane, delays due to the airport, etc.), taxiing data (e.g., time from departure to take-off, delays due to weather, delays due to air traffic control, delays due to the airport, whether the passengers were required to deplane, etc.), flight data (e.g., take-off time, landing time, time in the air, average speed, speed at each moment, altitude, fuel utilized, balance of the plane, the flight path, distance traveled, etc.), landing data (e.g., landing time, delays waiting for runway, etc.), and/or post-landing data (e.g., distance of runway to gate, time to taxi from runway to gate, unloading/debarking passengers time, unloading baggage time, cleaning time, time to change flight crew, time to refuel the plane, etc.). Various other quantifiable datum 118 can also be included and other information can be included for a flight or an airport.

In at least another embodiment, the detection service 109 can receive a plurality of instances of health data (i.e., instances of data 115). In at least some embodiments, each instance of health data can correspond to a period of time. In at least some embodiments, the period of time can be a fixed period of time. For example, the fixed period of time can include one or more minutes, one or more hours, one or more days, one or more months, one or more years, etc. In at least some embodiments, the health data can include a person's data (e.g., weight, height, dimensions/measurements, percentage fat, percentage water, muscle mass, blood pressure, etc.), prescription information (e.g., quantity and dosage of medicines, etc.), medical records (e.g., doctor's records, dental records, etc.), food information (e.g., food intake diary, caloric intake, water intake, etc.), fitness information (e.g., workouts, quantities of actions performed, time performing workout, etc.), and various other information.

In at least another embodiment, the detection service 109 can receive a plurality of instances of education data (i.e., instances of data 115). In at least some embodiments, each instance of education data can correspond to an assessment of the education objectives. In at least some embodiments, the education data can include assessment data (e.g., test scores, question responses, time to answer a question, time to complete the test, etc.), studying data (e.g., time spent reading, time spent studying, etc.), and various other information.

Next, at block 206, the detection service 109 can calculate the performance score for each instance of data 115. In some embodiments, the performance score can be calculated for each instance of data 115 by summing one or more quantifiable datum 118 within the instance of data 115. In some embodiments, the performance score can be calculated by choosing specific quantifiable datum 118 with each instance of data 115 to determine a more specific score. In at least some embodiments, at least one of the one or more quantifiable datum 118 within the instance of data 115 is weighted to provide greater importance to the one or more quantifiable datum 118. A weight might be a percentage or a decimal value that, when multiplied with the value, modifies the raw quantifiable datum 118 to a weighted quantifiable datum 118. Both raw quantifiable datum 118 and weighted quantifiable datum 118 can be used in the calculation of the performance score in various embodiments. In at least some embodiments, a quantifiable datum 118 can be a negative number, which would be able to negatively affect the performance score when calculating the performance score.

In at least some embodiments, the detection service 109 can calculate a performance score for each instance of video game data. In such a situation, the performance score could be calculated as previously discussed. In at least some embodiments, the video game data can include one or more statuses of the in-game character, which includes a health value. In such an embodiment, certain video game datum can have greater weight than other video game datum. For example, the health value can provide the greatest weight when calculating the performance score. In another example, the health value can provide no value or no weight in the calculation of the performance score. Any quantifiable datum 118 can be used as previously discussed with such an embodiment.

In at least some embodiments, the detection service 109 can calculate a performance score for each instance of flight data. In at least some embodiments, the performance score can be based at least on a delay to the flight, or any other quantifiable datum 118 as previously discussed. In at least some embodiments, the calculation can weight certain flight data with greater weight or with lesser weight, as previously discussed.

In at least some embodiments, the detection service 109 can calculate a performance score for each instance of health data. In at least some embodiments, the performance score can be based at least on an amount of exercise reported in the fixed period of time, the amount of food reported in a period of time, or any other quantifiable datum 118 as previously discussed. In at least some embodiments, the calculation can weight certain health data with greater weight or with lesser weight, as previously discussed.

In at least some embodiments, the detection service 109 can calculate a performance score for each instance of education data. In at least some embodiments, the performance score can be based at least on assessment data or any other quantifiable datum 118 as previously discussed. In at least some embodiments, the calculation can weight certain education data with greater weight or with lesser weight, as previously discussed.

Continuing with block 209, the detection service 109 can generate a time series plot. A time series can plot a shape of its context; in the case of a time series plot for this disclosure, the context that is plotted is the performance score over the times of each of the instances of data 115. A time series plot in this context can resemble a plurality of points in a two-dimensional grid. In at least some embodiments, the generation of the time series plot can be based on the performance score for two or more instances of data 115 and based on the corresponding period of time for the two or more instances of data 115. Due to the amount of data to generate a time series plot and the complexity of this plotting, it is impractical for humans to perform the steps of block 209.

It should be noted that the detection service 109 can generate a time series plot in various contexts. For example, the detection service 109 can generate a time series plot. In such an embodiment, the detection service 109 can generate the time series plot based on the performance score for two or more instances of video game data and the corresponding period of time for the instance of video game data. In another example, the detection service 109 can generate a time series plot based on the performance score for two or more instances of flight data and the corresponding flight time (or any other time for the flight). In another example, the detection service 109 can generate a time series plot based on the performance score for two or more instances of health data and the corresponding period of time for the instance of health data. In yet another example, the detection service 109 can generate a time series plot based on the performance score for two or more instances of education data and a corresponding date for which the assessment occurred.

Next, at block 212, the detection service 109 can measure the time series plot to generate a fractal dimension for the time series plot. A fractal can be a measure of complexity. Specifically, a fractal can be used to measure the complexity in the shape of figure. Fractal dimensions can be measures of that contextual complexity of that shape. Various methods can be used to measure the time series plot to generate a fractal dimension. In at least one embodiment, the box counting method can be used to measure the fractal dimension. The box counting method is a method of gathering data for analyzing complex patterns by breaking a dataset, object, image, etc. into smaller and smaller pieces, typically box-shaped and analyzing the pieces at each smaller scale. Other fractal dimension measuring methods could be used as well, such as the yard stick method, the variation method, the structure function method, the root mean square method, the R/S analysis method, and various other methods. In at least one embodiment, the fractal dimension that is generated can be represented as a value between one (1) and two (2). This range between the values one (1) and two (2) can be described as a scale. The scale represents the lower and the upper bounds of the values of the fractal dimension.

Continuing with block 215, the detection service 109 can rescale the fractal dimension to generate a rescaled fractal dimension. Because the fractal dimension for determining intervention can be so sensitive to detect (the value difference between determining whether intervention should be given or not be given being minute differences), the detection service 109 can rescale the fractal dimension to obtain more granular values of the fractal dimension. In at least one example, the fractal dimension is generated at a first scale of one (1) to two (2). In such an example, the fractal dimension can be rescaled to a second scale of zero (0) to four (4). It should be understood that the rescaling in this situation is a rescaling to a larger range of numbers. The rescaling can be performed using various mathematical and/or statistical formulas. In at least one embodiment, the fractal dimension can be rescaled using the “scales” package in the R programming language.

Next, at block 218, the detection service 109 can provide an intervention. In at least some embodiments, the detection service 109 can provide the intervention in response to determining that the rescaled fractal dimension is within a specified range. The specified range can be different based on the scale that is selected for the rescaled fractal dimension in block 215. In at least some embodiments with a scale of zero (0) to four (4), the specified range for the rescaled fractal dimension for providing the intervention can be between any value on or around three (3) to four (4). In the embodiment where the fractal dimension is rescaled to a scale of zero (0) to four (4), the specified ranges can be described in the following table (Table 1).

TABLE 1
Specified Ranges in a Scale of Zero (0) to Four (4)

| Range | Description | Requires Intervention? |
|---|---|---|
| 0-1 | The entity is not learning because the | No |
| | action is routine and predictable. | |
| 1-2 | The entity is learning by exploring new | No |
| | ideas and new methods. | |
| 2-3 | This entity is learning. | No |
| 3-3.44949 | This entity is learning, but not at the pace | Yes |
| | necessary to grow. Adaptive capacity will | |
| | decrease. | |
| 3.44949-3.54409 | This entity is learning in irregular intervals. | Yes |
| | Adaptive capacity will decrease | |
| 3.54409-3.56994 | This entity is learning with increasingly | Yes |
| | irregular intervals. Adaptive capacity will | |
| | decrease. | |
| ~3.56995 | This entity cannot continue learning without | Yes |
| | intervention. | |
| 3.56996-4 | This entity is not learning and cannot until | Yes |
| | external intervention is provided. | |

Various examples of interventions can be performed in response to determining the fractal dimension falls within the specified range. For example, the detection service 109 can provide an intervention that includes at least one of providing instruction to correct a specified behavior, making the action less difficult to perform, or other various interventions. In at least some embodiments, the detection service 109 can direct the client application 106 to perform the intervention on behalf of the detection service 109.

In some embodiments, the detection service 109 can provide, in response to determining that the rescaled fractal dimension is within a specified range, an intervention to correct behaviors in the video game. For example, an intervention can be provided that includes at least one of presenting a message to the player for how to correct the behavior, cause a user interface to illuminate a portion of the user interface, and/or provide haptic feedback to the player. In another embodiment, the detection service 109 can provide, in response to determining that the rescaled fractal dimension is within a specified range, an intervention to increase the performance score for subsequent flights. In yet another embodiment, the detection service 109 can provide, in response to determining that the rescaled fractal dimension is within a specified range, an intervention to further the education objectives.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart shows the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowchart shows a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowchart can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Various embodiments of the present disclosure are described in the following clauses. Although the following clauses describe some embodiments of the present disclosure, other embodiments of the present disclosure are also set forth above.
Clause 1—A method, comprising receiving a plurality of instances of data, each instance of data corresponding to an action being performed over a period of time; calculating a performance score for each instance of data; generating, based on the performance score for two or more instances of data and based on the corresponding period of time for the two or more instances of data, a time series plot; measuring the time series plot to generate a fractal dimension for the time series plot; rescaling the fractal dimension to generate a rescaled fractal dimension; and providing, in response to determining that the rescaled fractal dimension is within a specified range, an intervention.
Clause 2—The method of clause 1, wherein the action is performed by one or more persons to generate the plurality of instances of data, the one or more persons each identifying as performing at a high skill level.
Clause 3—The method of clause 1, wherein the action is performed by one or more persons to generate the plurality of instances of data, the one or more persons each identifying as performing at a low skill level.
Clause 4—The method of any of clauses 1-3, wherein the performance score is calculated for each instance of data by summing one or more datum within the instance of data.
Clause 5—The method of clause 4, wherein at least one of the one or more datum within the instance of data is weighted to provide greater importance to the one or more datum.
Clause 6—The method of any of clauses 1-5, wherein the time series plot is measured using a box counting method.
Clause 7—The method of any of clauses 1-6, wherein the fractal dimension is generated at a first scale of 1 to 2 and the fractal dimension is rescaled to a second scale of 0 to 4.
Clause 8—The method of clause 7, wherein the specified range for the rescaled fractal dimension for providing the intervention is between a value of 3 and 3.56995.
Clause 9—The method of any of clauses 1-8, wherein the intervention that is provided includes at least one of providing instruction to correct a specified behavior or making the action less difficult.
Clause 10—A system, comprising a computing device comprising a processor and a memory; and machine-readable instructions stored in the memory that, when executed by the processor, cause the computing device to at least receive a plurality of instances of data, each instance of data corresponding to an action being performed over a period of time; calculate a performance score for each instance of data; generate, based on the performance score for two or more instances of data and based on the corresponding period of time for the two or more instances of data, a time series plot; measure the time series plot to generate a fractal dimension for the time series plot; rescale the fractal dimension to generate a rescaled fractal dimension; and provide, in response to determining that the rescaled fractal dimension is within a specified range, an intervention.
Clause 11—The system of clause 10, wherein the action is performed by one or more persons to generate the plurality of instances of data, the one or more persons each identifying as performing at a high skill level.
Clause 12—The system of clause 10, wherein the action is performed by one or more persons to generate the plurality of instances of data, the one or more persons each identifying as performing at a low skill level.
Clause 13—The system of any of clauses 10-12, wherein the performance score is calculated for each instance of data by summing one or more datum within the instance of data.
Clause 14—The system of clause 13, wherein at least one of the one or more datum within the instance of data is weighted to provide greater importance to the one or more datum.
Clause 15—The system of any of clauses 10-14, wherein the time series plot is measured using a box counting method.
Clause 16—The system of any of clauses 10-15, wherein the fractal dimension is generated at a first scale of 1 to 2 and the fractal dimension is rescaled to a second scale of 0 to 4.
Clause 17—The system of clause 16, wherein the specified range for the rescaled fractal dimension for providing the intervention is between a value of 3 and 3.56995.
Clause 18—The system of any of clauses 10-17, wherein the intervention that is provided includes at least one of providing instruction to correct a specified behavior or making the action less difficult.
Clause 19—A non-transitory, computer-readable medium, comprising machine-readable instructions that, when executed by a processor, cause a computing device to at least receive a plurality of instances of data, each instance of data corresponding to an action being performed over a period of time; calculate a performance score for each instance of data; generate, based on the performance score for two or more instances of data and based on the corresponding period of time for the two or more instances of data, a time series plot; measure the time series plot to generate a fractal dimension for the time series plot; rescale the fractal dimension to generate a rescaled fractal dimension; and provide, in response to determining that the rescaled fractal dimension is within a specified range, an intervention.
Clause 20—The non-transitory, computer-readable medium of clause 19, wherein the action is performed by one or more persons to generate the plurality of instances of data, the one or more persons each identifying as performing at a high skill level.
Clause 21—The non-transitory, computer-readable medium of clause 19, wherein the action is performed by one or more persons to generate the plurality of instances of data, the one or more persons each identifying as performing at a low skill level.
Clause 22—The non-transitory, computer-readable medium of any of clauses 19-21, wherein the performance score is calculated for each instance of data by summing one or more datum within the instance of data.
Clause 23—The non-transitory, computer-readable medium of clause 22, wherein at least one of the one or more datum within the instance of data is weighted to provide greater importance to the one or more datum.
Clause 24—The non-transitory, computer-readable medium of any of clauses 19-23, wherein the time series plot is measured using a box counting method.
Clause 25—The non-transitory, computer-readable medium of any of clauses 19-24, wherein the fractal dimension is generated at a first scale of 1 to 2 and the fractal dimension is rescaled to a second scale of 0 to 4.
Clause 26—The non-transitory, computer-readable medium of clause 25, wherein the specified range for the rescaled fractal dimension for providing the intervention is between a value of 3 and 3.56995.
Clause 27—The non-transitory, computer-readable medium of any of clauses 19-26, wherein the intervention that is provided includes at least one of providing instruction to correct a specified behavior or making the action less difficult.
Clause 28—A method for detecting that a player requires intervention in a video game, comprising receiving a plurality of instances of video game data, each instance of video game data corresponding to a period of time which the player is playing the video game; calculating a performance score for each instance of video game data; generating, based on the performance score for two or more instances of video game data and the corresponding period of time for the instance of video game data, a time series plot; measuring the time series plot to generate a fractal dimension for the time series plot; rescaling the fractal dimension to generate a rescaled fractal dimension; and providing, in response to determining that the rescaled fractal dimension is within a specified range, an intervention to correct behaviors in the video game.
Clause 29—The method of clause 28, wherein the period of time is indicative of period of play time between starting the game and a player failure.
Clause 30—The method of clause 29, wherein the player failure is at least one of an in-game death, an end of round of game play, or a loss of an in-game value.
Clause 31—The method of any of clauses 28-30, wherein each instance of video game data comprises position data of an in-game character, one or more statuses of the in-game character, and environment information.
Clause 32—The method of clause 31, wherein the one or more statuses of the in-game character includes a health value and the health value is provided a greatest weight when calculating the performance score.
Clause 33—The method of any of clauses 28-32, wherein the time series plot is measured using a box counting method.
Clause 34—The method of any of clauses 28-33, wherein the fractal dimension is generated at a first scale of 1 to 2 and the fractal dimension is rescaled to a second scale of 0 to 4.
Clause 35—The method of clause 34, wherein the specified range for the rescaled fractal dimension for providing the intervention is between a value of 3 and 4.
Clause 36—The method of any of clauses 28-35, wherein the intervention that is provided includes at least one of presenting a message to the player for how to correct the behaviors, cause a user interface to illuminate a portion of the user interface, provide haptic feedback to the player.
Clause 37—A system for detecting that a player requires intervention in a video game, comprising a computing device comprising a processor and a memory; and machine-readable instructions stored in the memory that, when executed by the processor, cause the computing device to at least receive a plurality of instances of video game data, each instance of video game data corresponding to a period of time which the player is playing the video game; calculate a performance score for each instance of video game data; generate, based on the performance score for two or more instances of video game data and the corresponding period of time for the instance of video game data, a time series plot; measure the time series plot to generate a fractal dimension for the time series plot; rescale the fractal dimension to generate a rescaled fractal dimension; and provide, in response to determining that the rescaled fractal dimension is within a specified range, an intervention to correct behaviors in the video game.
Clause 38—The system of clause 37, wherein the period of time is indicative of period of play time between starting the game and a player failure.
Clause 39—The system of clause 38, wherein the player failure is at least one of an in-game death, an end of round of game play, or a loss of an in-game value.
Clause 40—The system of any of clauses 37-39, wherein each instance of video game data comprises position data of an in-game character, one or more statuses of the in-game character, and environment information.
Clause 41—The system of clause 40, wherein the one or more statuses of the in-game character includes a health value and the health value is provided a greatest weight when calculating the performance score.
Clause 42—The system of any of clauses 37-41, wherein the time series plot is measured using a box counting method.
Clause 43—The system of any of clauses 37-42, wherein the fractal dimension is generated at a first scale of 1 to 2 and the fractal dimension is rescaled to a second scale of 0 to 4.
Clause 44—The system of clause 43, wherein the specified range for the rescaled fractal dimension for providing the intervention is between a value of 3 and 4.
Clause 45—The system of any of clauses 37-44, wherein the intervention that is provided includes at least one of presenting a message to the player for how to correct the behaviors, cause a user interface to illuminate a portion of the user interface, provide haptic feedback to the player.
Clause 46—A non-transitory, computer-readable medium for detecting that a player requires intervention in a video game, comprising machine-readable instructions that, when executed by a processor, cause a computing device to at least receive a plurality of instances of video game data, each instance of video game data corresponding to a period of time which the player is playing the video game; calculate a performance score for each instance of video game data; generate, based on the performance score for two or more instances of video game data and the corresponding period of time for the instance of video game data, a time series plot; measure the time series plot to generate a fractal dimension for the time series plot; rescale the fractal dimension to generate a rescaled fractal dimension; and provide, in response to determining that the rescaled fractal dimension is within a specified range, an intervention to correct behaviors in the video game.
Clause 47—The non-transitory, computer-readable medium of clause 46, wherein the period of time is indicative of period of play time between starting the game and a player failure.
Clause 48—The non-transitory, computer-readable medium of clause 47, wherein the player failure is at least one of an in-game death, an end of round of game play, or a loss of an in-game value.
Clause 49—The non-transitory, computer-readable medium of any of clauses 46-48, wherein each instance of video game data comprises position data of an in-game character, one or more statuses of the in-game character, and environment information.
Clause 50—The non-transitory, computer-readable medium of clause 49, wherein the one or more statuses of the in-game character includes a health value and the health value is provided a greatest weight when calculating the performance score.
Clause 51—The non-transitory, computer-readable medium of any of clauses 46-50, wherein the time series plot is measured using a box counting method.
Clause 52—The non-transitory, computer-readable medium of any of clauses 46-51, wherein the fractal dimension is generated at a first scale of 1 to 2 and the fractal dimension is rescaled to a second scale of 0 to 4.
Clause 53—The non-transitory, computer-readable medium of clause 52, wherein the specified range for the rescaled fractal dimension for providing the intervention is between a value of 3 and 4.
Clause 54—The non-transitory, computer-readable medium of any of clauses 46-53, wherein the intervention that is provided includes at least one of presenting a message to the player for how to correct the behaviors, cause a user interface to illuminate a portion of the user interface, provide haptic feedback to the player.
Clause 55—A method for detecting that a flight plan for a plane within an airline requires intervention, comprising receiving a plurality of instances of flight data, each instance of flight data corresponding to a flight within the flight plan, calculating a performance score for each instance of flight data, wherein the performance score is based at least on a delay to the flight; generating, based on the performance score for two or more instances of flight data and the corresponding flight time, a time series plot; measuring the time series plot to generate a fractal dimension for the time series plot; rescaling the fractal dimension to generate a rescaled fractal dimension; and providing, in response to determining that the rescaled fractal dimension is within a specified range, an intervention to increase the performance score for subsequent flights.
Clause 56—The method of clause 55, wherein each instance of flight data includes pre-boarding data, boarding data, taxiing data, flight data, landing data, and post-landing data.
Clause 57—The method of clause 55 or clause 56, wherein the time series plot is measured using a box counting method.
Clause 58—The method of any of clauses 55-57, wherein the fractal dimension is generated at a first scale of 1 to 2 and the fractal dimension is rescaled to a second scale of 0 to 4.
Clause 59—The method of clause 58, wherein the specified range for the rescaled fractal dimension for providing the intervention is between a value of 3 and 3.54409.
Clause 60—A system for detecting that a flight plan for a plane within an airline requires intervention, comprising a computing device comprising a processor and a memory; and machine-readable instructions stored in the memory that, when executed by the processor, cause the computing device to at least receive a plurality of instances of flight data, each instance of flight data corresponding to a flight within the flight plan, calculate a performance score for each instance of flight data, wherein the performance score is based at least on a delay to the flight; generate, based on the performance score for two or more instances of flight data and the corresponding flight time, a time series plot; measure the time series plot to generate a fractal dimension for the time series plot; rescale the fractal dimension to generate a rescaled fractal dimension; and provide, in response to determining that the rescaled fractal dimension is within a specified range, an intervention to increase the performance score for subsequent flights.
Clause 61—The system of clause 60, wherein each instance of flight data includes pre-boarding data, boarding data, taxiing data, flight data, landing data, and post-landing data.
Clause 62—The system of clause 60 or clause 61, wherein the time series plot is measured using a box counting method.
Clause 63—The system of any of clauses 60-62, wherein the fractal dimension is generated at a first scale of 1 to 2 and the fractal dimension is rescaled to a second scale of 0 to 4.
Clause 64—The system of clause 63, wherein the specified range for the rescaled fractal dimension for providing the intervention is between a value of 3 and 3.54409.
Clause 65—A non-transitory, computer-readable medium for detecting that a flight plan for a plane within an airline requires intervention, comprising machine-readable instructions that, when executed by a processor, cause a computing device to at least receive a plurality of instances of flight data, each instance of flight data corresponding to a flight within the flight plan, calculate a performance score for each instance of flight data, wherein the performance score is based at least on a delay to the flight; generate, based on the performance score for two or more instances of flight data and the corresponding flight time, a time series plot; measure the time series plot to generate a fractal dimension for the time series plot; rescale the fractal dimension to generate a rescaled fractal dimension; and provide, in response to determining that the rescaled fractal dimension is within a specified range, an intervention to increase the performance score for subsequent flights.
Clause 66—The non-transitory, computer-readable medium of clause 65, wherein each instance of flight data includes pre-boarding data, boarding data, taxiing data, flight data, landing data, and post-landing data.
Clause 67—The non-transitory, computer-readable medium of clause 65 or clause 65, wherein the time series plot is measured using a box counting method.
Clause 68—The non-transitory, computer-readable medium of any of clauses 65-67, wherein the fractal dimension is generated at a first scale of 1 to 2 and the fractal dimension is rescaled to a second scale of 0 to 4.
Clause 69—The non-transitory, computer-readable medium of clause 68, wherein the specified range for the rescaled fractal dimension for providing the intervention is between a value of 3 and 3.54409.
Clause 70—A method for detecting that a person requires intervention to lose weight, comprising receiving a plurality of instances of health data, each instance of health data corresponding to a fixed period of time; calculating a performance score for each instance of health data; generating, based on the performance score for two or more instances of health data and the corresponding fixed period of time for the instance of health data, a time series plot; measuring the time series plot to generate a fractal dimension for the time series plot; rescaling the fractal dimension to generate a rescaled fractal dimension; and providing, in response to determining that the rescaled fractal dimension is within a specified range, an intervention.
Clause 71—The method of clause 70, wherein the fixed period of time is at least one of a day, a week, or a month.
Clause 72—The method of clause 70 or clause 71, wherein the performance score is based at least on an amount of exercise reported in the fixed period of time and an amount of food reported in the fixed period of time.
Clause 73—The method of any of clauses 70-72, wherein the time series plot is measured using a box counting method.
Clause 74—The method of any of clauses 70-73, wherein the fractal dimension is generated at a first scale of 1 to 2 and the fractal dimension is rescaled to a second scale of 0 to 4.
Clause 75—The method of clause 74, wherein the specified range for the rescaled fractal dimension for providing the intervention is between a value of 3.44949 and 4.
Clause 76—A system for detecting that a person requires intervention to lose weight, comprising a computing device comprising a processor and a memory; and machine-readable instructions stored in the memory that, when executed by the processor, cause the computing device to at least receive a plurality of instances of health data, each instance of health data corresponding to a fixed period of time; calculate a performance score for each instance of health data; generate, based on the performance score for two or more instances of health data and the corresponding fixed period of time for the instance of health data, a time series plot; measure the time series plot to generate a fractal dimension for the time series plot; rescale the fractal dimension to generate a rescaled fractal dimension; and provide, in response to determining that the rescaled fractal dimension is within a specified range, an intervention.
Clause 77—The system of clause 76, wherein the fixed period of time is at least one of a day, a week, or a month.
Clause 78—The system of clause 76 or clause 77, wherein the performance score is based at least on an amount of exercise reported in the fixed period of time and an amount of food reported in the fixed period of time.
Clause 79—The system of any of clauses 76-78, wherein the time series plot is measured using a box counting method.
Clause 80—The system of any of clauses 76-79, wherein the fractal dimension is generated at a first scale of 1 to 2 and the fractal dimension is rescaled to a second scale of 0 to 4.
Clause 81—The system of clause 80, wherein the specified range for the rescaled fractal dimension for providing the intervention is between a value of 3.44949 and 4.
Clause 82—A non-transitory, computer-readable medium for detecting that a person requires intervention to lose weight, comprising machine-readable instructions that, when executed by a processor, cause a computing device to at least receive a plurality of instances of health data, each instance of health data corresponding to a fixed period of time; calculate a performance score for each instance of health data; generate, based on the performance score for two or more instances of health data and the corresponding fixed period of time for the instance of health data, a time series plot; measure the time series plot to generate a fractal dimension for the time series plot; rescale the fractal dimension to generate a rescaled fractal dimension; and provide, in response to determining that the rescaled fractal dimension is within a specified range, an intervention.
Clause 83—The non-transitory, computer-readable medium of clause 82, wherein the fixed period of time is at least one of a day, a week, or a month.
Clause 84—The non-transitory, computer-readable medium of clause 82 or clause 83, wherein the performance score is based at least on an amount of exercise reported in the fixed period of time and an amount of food reported in the fixed period of time.
Clause 85—The non-transitory, computer-readable medium of any of clauses 82-84, wherein the time series plot is measured using a box counting method.
Clause 86—The non-transitory, computer-readable medium of any of clauses 82-85, wherein the fractal dimension is generated at a first scale of 1 to 2 and the fractal dimension is rescaled to a second scale of 0 to 4.
Clause 87—The non-transitory, computer-readable medium of clause 86, wherein the specified range for the rescaled fractal dimension for providing the intervention is between a value of 3.44949 and 4.
Clause 88—A method for detecting that a person requires intervention to obtain education objectives, comprising receiving a plurality of instances of education data, each instance of education data corresponding to an assessment of the education objectives; calculating a performance score for each instance of education data; generating, based on the performance score for two or more instances of education data and a corresponding date for which the assessment occurred, a time series plot; measuring the time series plot to generate a fractal dimension for the time series plot; rescaling the fractal dimension to generate a rescaled fractal dimension; and providing, in response to determining that the rescaled fractal dimension is within a specified range, an intervention to further the education objectives.
Clause 89—The method of clause 88, wherein the time series plot is measured using a box counting method.
Clause 90—The method of clause 88 or clause 89, wherein the fractal dimension is generated at a first scale of 1 to 2 and the fractal dimension is rescaled to a second scale of 0 to 4.
Clause 91—The method of clause 90, wherein the specified range for the rescaled fractal dimension for providing the intervention is between a value of 3 and 4.
Clause 92—A system for detecting that a person requires intervention to obtain education objectives, comprising a computing device comprising a processor and a memory; and machine-readable instructions stored in the memory that, when executed by the processor, cause the computing device to at least receive a plurality of instances of education data, each instance of education data corresponding to an assessment of the education objectives; calculate a performance score for each instance of education data; generate, based on the performance score for two or more instances of education data and a corresponding date for which the assessment occurred, a time series plot; measure the time series plot to generate a fractal dimension for the time series plot; rescale the fractal dimension to generate a rescaled fractal dimension; and provide, in response to determining that the rescaled fractal dimension is within a specified range, an intervention to further the education objectives.
Clause 93—The system of clause 92, wherein the time series plot is measured using a box counting method.
Clause 94—The system of clause 92 or clause 93, wherein the fractal dimension is generated at a first scale of 1 to 2 and the fractal dimension is rescaled to a second scale of 0 to 4.
Clause 95—The system of clause 94, wherein the specified range for the rescaled fractal dimension for providing the intervention is between a value of 3 and 4.
Clause 96—A non-transitory, computer-readable medium for detecting that a person requires intervention to obtain education objectives, comprising machine-readable instructions that, when executed by a processor, cause a computing device to at least receive a plurality of instances of education data, each instance of education data corresponding to an assessment of the education objectives; calculate a performance score for each instance of education data; generate, based on the performance score for two or more instances of education data and a corresponding date for which the assessment occurred, a time series plot; measure the time series plot to generate a fractal dimension for the time series plot; rescale the fractal dimension to generate a rescaled fractal dimension; and provide, in response to determining that the rescaled fractal dimension is within a specified range, an intervention to further the education objectives.
Clause 97—The non-transitory, computer-readable medium of clause 96, wherein the time series plot is measured using a box counting method.
Clause 98—The non-transitory, computer-readable medium of clause 96 or clause 97, wherein the fractal dimension is generated at a first scale of 1 to 2 and the fractal dimension is rescaled to a second scale of 0 to 4.
Clause 99—The non-transitory, computer-readable medium of clause 98, wherein the specified range for the rescaled fractal dimension for providing the intervention is between a value of 3 and 4.

Therefore, the following is claimed:

1. A method, comprising:
receiving a plurality of instances of data, each instance of data corresponding to an action being performed over a period of time;
calculating a performance score for each instance of data;
generating, based on the performance score for two or more instances of data and based on the corresponding period of time for the two or more instances of data, a time series plot;
measuring the time series plot to generate a fractal dimension for the time series plot;
rescaling the fractal dimension to generate a rescaled fractal dimension; and
providing, in response to determining that the rescaled fractal dimension is within a specified range, an intervention.

2. The method of claim 1, wherein the performance score is calculated for each instance of data by summing one or more datum within the instance of data.

3. The method of claim 2, wherein at least one of the one or more datum within the instance of data is weighted to provide greater importance to the one or more datum.

4. The method of claim 1, wherein the time series plot is measured using a box counting method.

5. The method of claim 1, wherein the fractal dimension is generated at a first scale of 1 to 2 and the fractal dimension is rescaled to a second scale of 0 to 4.

6. The method of claim 5, wherein the specified range for the rescaled fractal dimension for providing the intervention is between a value of 3 and 3.56995.

7. The method of claim 1, wherein the intervention that is provided includes at least one of providing instruction to correct a specified behavior or making the action less difficult.

8. A system, comprising:
a computing device comprising a processor and a memory; and
machine-readable instructions stored in the memory that, when executed by the processor, cause the computing device to at least:
receive a plurality of instances of data, each instance of data corresponding to an action being performed over a period of time;
calculate a performance score for each instance of data;
generate, based on the performance score for two or more instances of data and based on the corresponding period of time for the two or more instances of data, a time series plot;
measure the time series plot to generate a fractal dimension for the time series plot;
rescale the fractal dimension to generate a rescaled fractal dimension; and
provide, in response to determining that the rescaled fractal dimension is within a specified range, an intervention.

9. The system of claim 8, wherein the action is performed by one or more persons to generate the plurality of instances of data, the one or more persons each identifying as performing at a high skill level.

10. The system of claim 8, wherein the performance score is calculated for each instance of data by summing one or more datum within the instance of data.

11. The system of claim 8, wherein at least one of the one or more datum within the instance of data is weighted to provide greater importance to the one or more datum.

12. The system of claim 8, wherein the time series plot is measured using a box counting method.

13. The system of claim 8, wherein the fractal dimension is generated at a first scale of 1 to 2 and the fractal dimension is rescaled to a second scale of 0 to 4.

14. The system of claim 8, wherein the intervention that is provided includes at least one of providing instruction to correct a specified behavior or making the action less difficult.

15. A non-transitory, computer-readable medium, comprising machine-readable instructions that, when executed by a processor, cause a computing device to at least:
receive a plurality of instances of data, each instance of data corresponding to an action being performed over a period of time;
calculate a performance score for each instance of data;
generate, based on the performance score for two or more instances of data and based on the corresponding period of time for the two or more instances of data, a time series plot;
measure the time series plot to generate a fractal dimension for the time series plot;
rescale the fractal dimension to generate a rescaled fractal dimension; and
provide, in response to determining that the rescaled fractal dimension is within a specified range, an intervention.

16. The non-transitory, computer-readable medium of claim 15, wherein the action is performed by one or more persons to generate the plurality of instances of data, the one or more persons each identifying as performing at a low skill level.

17. The non-transitory, computer-readable medium of claim 15, wherein the performance score is calculated for each instance of data by summing one or more datum within the instance of data.

18. The non-transitory, computer-readable medium of claim 17, wherein at least one of the one or more datum within the instance of data is weighted to provide greater importance to the one or more datum.

19. The non-transitory, computer-readable medium of claim 15, wherein the time series plot is measured using a box counting method.

20. The non-transitory, computer-readable medium of claim 15, wherein the fractal dimension is generated at a first scale of 1 to 2 and the fractal dimension is rescaled to a second scale of 0 to 4.
